(19) United States
(12) Patent Application Publication
(10) Pub. No.: US 2004/0097281 A1
(43) Pub. Date: May 20, 2004

(54) Betting method and system for comparing products and services

(76) Inventor: Michael T. Rossides, Scottsdale, AZ (US)

Correspondence Address: Michael T. Rossides, 11167 E. Mirasol Circle, Scottsdale, AZ, 85255, US

(21) Appl. No.: 10/442,794

(22) Filed: May 20, 2003

Related U.S. Application Data
(60) Provisional application No. 60/426,971, filed on Nov. 15, 2002.

(51) Int. Cl. G06F 19/00

(52) U.S. Cl. 463/16

(57) ABSTRACT

We disclose a betting method in which the terms of a product bet contest are created, defining a contest between two or more products. The contest terms spell out the rules for judging which product is better or best. The terms also spell out the rules for risking money on the outcome of the contest. Users may make bet offers by risking money that a product will be shown to be better according to the rules of the contest. If possible, offers are matched, judging is triggered, and monies are divided according to the outcome and rules of the contest. At all stages in the betting process, data can be viewed showing the product bet contest and how users are betting on the contest.

### CROSS-REFERENCES TO RELATED APPLICATIONS

This application traces priority to disclosure documents 512,686 (filing date Jun. 3, 2002) and 523,794 (filing date Dec. 24, 2002).

This application traces priority to provisional patent application No. 60/426,971 (filing date Nov. 15, 2002).

This application refers to U.S. Pat. Nos. 5,575,474 and 6,443,841.

### STATEMENT REGARDING FEDERALLY FUNDED RESEARCH

Not applicable.

### BACKGROUND

1. Field of the Invention

The invention relates to betting methods and media (sometimes called markets) for communicating opinions. It also relates to advertising methods and media.

2. Description of Related Art

U.S. Pat. Nos. 5,575,474 and 6,443,841 disclose methods and systems for using bets to communicate. The Iowa Electronic Markets (http://www.biz.uiowa.edu/iem) enable users to express their opinions on several matters, especially on who is going to win an election. The Hollywood Stock Exchange (www.hsx.com) provides a market system for enabling users to express their opinions on how movies and movie stars will perform. Robin Hanson (http://hanson.gmu.edu/gamble.html) has proposed a betting market to allow people to express scientific opinions.

This application describes a narrower invention than a general method and medium for communicating opinions through bets. It is an invention for solving the more specific problem of how to communicate that one product is better than another product.

So, the invention differs from the prior art in the sense that a tow truck differs from the more general invention of a motorized vehicle or that a sports bet market differs from the more general invention of a market. Accordingly, the invention differs from the prior art in the kinds of bet offers and contracts it enables and in the information it generates. It differs in:

the subject matter of the bet offers and contracts

the terms of the offers and contracts

the input options presented to users

the output options presented to users

the user actions

the steps for displaying and transacting these offers and contracts

the bet results and other information generated.

### OBJECT OF THE INVENTION

The object of the invention is to provide a better way to communicate that a product or service is better than competing products or services.

### BRIEF SUMMARY OF THE INVENTION

We disclose a betting method in which the terms of a product bet contest are created, defining a contest between two or more products. The contest terms spell out the rules for judging which product is better or best. The terms also spell out the rules for risking money on the outcome of the contest. Users may make bet offers by risking money that a product will be shown to be better according to the rules of the contest. If possible, offers are matched, judging is triggered, and monies are divided according to the outcome and rules of the contest. At all stages in the betting process, data can be viewed showing the product bet contest and how users are betting on the contest.

### BRIEF DESCRIPTION OF THE DRAWINGS

Drawing 1 shows a form for entering the parameters of a bet contest into a database.

### DETAILED DESCRIPTION OF THE INVENTION

### Outline of Specification, Our Approach to Describing the Invention

The Preface of this specification describes the general problem that the disclosed invention addresses and the general solution provided by the invention.

Prefatory Definitions provide definitions of some basic terms that are used throughout this specification, including the classes of users of the invention.

Part 1 of this specification describes a set of core modules, which are processes that comprise an expansive embodiment of the inventive method and direct the operation of the medium that implements the method.

The first three core modules enable (1) the creation of a bet contest for comparing products, (2) the display of bet contest and bet offers and, (3) the risking of money on a product—the making of a bet offer, that is. These three modules can stand alone as the foundation of the expansive embodiment. The other eight modules add functionality.

In practice, most, if not all, of the modules will probably be implemented together, but it is possible to decompose the expansive embodiment into sub-processes that are performed by different entities.

As discussed, the invention enables special purpose bets. These bets are defined by rules, so each module represents a set of steps for implementing some of these rules.

The modules are high-level descriptions that we use for clarity. The modules themselves can be decomposed into smaller set of steps, and rearranged, as is apparent to those skilled in technical writing or programming can see. The goal of this specification is to disclose the key novel elements and steps of the inventive method and medium. There is no ideal way to present these elements and steps, therefore, those skilled in technical writing or programming will see better ways to organize and present this disclosure.

Part 2 elaborates on Module 1 of Part 1, describing elements and steps of the invention that enable a user to set the parameters that create a bet contest for comparing products.

Part 3—planned, but NOT INCLUDED—also elaborates on Module 1 of Part 1, delving into the creation of a bet contest, elaborating on how the invention enables a user to specify the products being compared in a bet contest. Part 3 discloses a variety of useful comparison sets.

Part 4—planned, but NOT INCLUDED—also elaborates on Module 1 of Part 1, delving into the creation of a bet contest, elaborating on how the invention enables a user to specify the comparison question that the bet contest is about. Part 4 discloses a variety of useful comparison questions.

Part 5—planned, but NOT INCLUDED—is short and describes elements and steps that enable a user to direct (target) a bet offer to a person, category of persons, or entity.

Part 6—planned, but NOT INCLUDED—describes methods for enhancing the information of a product bet offer by registering, authenticating and displaying data about bettors and bet offer targets.

### Standardized Aspects of Bets in Practice

A bet can be custom written from the ground up but, in practice, most of the rules and terms will be standard for transactional simplicity, as with any market.

For example, the method may be implemented such that the author of a bet contest may only have the freedom of choice to pick the competing products in the contest, with the rest of the terms and rules being held standard.

For the purpose of disclosing the inventive method, we will describe how user can set virtually all the terms and rules in a bet contest. We cannot say which terms will be held standard in practice, but we realize that in practice users usually will not have the full freedom of choice described.

We also note that one aspect of the invention is that it enables users to select from standardized options for making product contest bets, thereby relieving users of the heavy transaction costs of creating custom contract offers and trying to get other people to accept those custom offers. (As with other transaction methods and systems, standard terms may be incorporated by reference, or by a link on a screen that is output to users.)

### ILLUSTRATIVE EXAMPLES

Examples are given throughout. Those skilled in the art will know that the examples are illustrative only and do not limit the range of applications of the present invention. In presenting the core modules, we will usually use the illustrative example of two aspirins, Bayer and Costco, being pitted against each other in a bet. Another example will be two cars pitted against each other, and two car repair operations pitted against each other. However, a problem with relying mainly a few examples is that they do not show the full panoply of problems that arise in trying to make useful comparisons between products. So, other examples will be used as well.

### Preface

The Problem: How to Demonstrate that One Product is Better than Another

A basic problem for an advertiser of a product (or service) is how to demonstrate that the product is better than a competing product.

An advertiser seeks to demonstrate:

(a) a competitive advantage, or advantages, or overall better value

(b) versus a competitor or competitors

(c) to a set of prospects.

For example, consider a generic aspirin that has the same composition as Bayer aspirin, a well-known brand, and that costs less than Bayer. The generic appears to be clearly a better value, and yet Bayer will still sell when presented side by side with the generic. How is the seller of the generic to demonstrate, “prove,” that the generic is a better value?

Consider a new restaurant, Patrice, which offers better tasting food at a lower price than The Cheesecake Factory, a well-known chain. How is Patrice to demonstrate, “prove,” that it offers a better product than the Cheesecake Factory?

There is the philosophical and practical issue of how to “prove” a subjective assertion—“my product is better than that product.”

Then, there is also the problem of how to make the “proof” available to prospects.

These are profound problems in the world of selling—how to make a convincing demonstration that a product is better than another, and how to inform prospects of that demonstration.

Given unlimited money, the solutions may be apparent, but given a limited advertising budget, the problems have not been solved well. It is expensive to deliver a sales message to prospects, and that self-serving message is usually suspect.

Here we will describe a method and medium that can, at a relatively low cost, allow people to publicly and convincingly demonstrate that one product is better than another.

Solution: Method and Medium for Making Bets on Competing Products

Our solution to the advertising problems above is a novel method implemented by users and a medium that enable people to make public bets about competing products, i.e., to publicly bet that product X is better than product Y.

For example, using the method, a bet could be created that pits a generic aspirin against Bayer Aspirin, and anyone could then bet on one or the other.

The inventive method also enables people who sell products to publicly engage in these bets. Willingness to bet shows that a seller has confidence in his product. Unwillingness to bet shows a lack of confidence.

Thus, when prospects view a bet pitting two products they see which product the betting market thinks is better. Prospects also see what the sellers of the two products—the people often in the best position to know—think is the better product.

Of course, we have oversimplified: judging and demonstrating that one product is better than another is a multifaceted problem that admits no single, simple solution. Hence, a betting solution will vary depending on many factors, including the products being compared, the money available to judge the products, the rules of the judging, and the preferences of the prospective buyers. Therefore, the inventive method encompasses a great variety of bets and corresponding processes.

### Prefatory Definitions

Product

In this specification, the term product refers to anything that is sold or leased. Thus, it encompasses all services and other things for sale or lease, such as real estate. We usually use product alone simply because it is shorter than saying product or service.

A Bet

The term bet is confusing because it can refer to different things. A bet can be a kind of statement in the sense that someone making a bet offer is making a statement. A bet can be an offer or contract that defines how two opposing bettors can risk money against each other on the outcome of an uncertain event. A bet, therefore, can also be, explicitly or implicitly, a set of rules that define the uncertain event and how people can risk money on the event. In common parlance, to make a bet often refers to risking money in a bet contract. But, in this specification, making a bet—the entire process—has many parts. Bet can encompass all aspects involved in the creation of the rules of a bet, the making of a bet offer, the matching of bet offers, and various other steps in the transaction of a bet contract. So, when we use bet we will let the context determine its meaning.

The Inventive Method

The inventive method is a set of rules, data elements and processes that, in combination, allow users to place, view and possibly transact useful bets concerning whether one product is better than another product. Rules for bets are highly variable, which means that the method can encompass a variety of different rules. As discussed, we first describe a general method and then describe more specific sub-methods. An analogy is poker. One can describe a general method for playing poker and also describe particular games. Another analogy is the trading of securities. One can describe a general method for trading securities and also describe more specific, differing methods for trading stocks and trading bonds.

The Inventive Medium

The inventive medium (which may also be called a system, as in the title) is an online, interactive computer database system, connected to a network of terminals, which incorporates and implements the inventive method. By analogy, one can think of an automated market, or a Totalizer and ticket issuing system at a racetrack.

Users

The invention in most implementations will have five different classes of users:

(1) Authors: An author creates the bet contest involving at least two products. An author may be an individual or an entity (such as a company).

(2) Bettors: A bettor risks money on a product in a bet. He may also be an author. A bettor may be an individual or an entity (such as a company).

(3) Viewers: A viewer views a bet. He may also be an author.

(4) Judges: A judge judges whether one product is better than another, as defined by the product contest rules. A judge enters his judgment, the bet result, into the medium.

(5) Administrators: An administrator establishes the conventions of the medium, such as the standard betting rules. He may also assist other users, such as authors and judges, in inputting data and editing bet contests. He may also be an author.

Thus, for example, an author may create a contest pitting Bayer Aspirin against Costco Aspirin. A bettor then risks money that one of the aspirins will win the contest. Another bettor may take the same side or the opposite side. A viewer may find and display the bet data. A judge may judge which aspirin wins the contest.

### Part 1

Core Modules

The core modules described below are numbered for convenience, although the execution of one module does not necessarily depend on the execution of the preceding module. The execution of the modules depends upon the situation, on what a user is doing. For instance, two users may make bet offers that are matched, but does not mean the bet must next be settled; it may never be settled. Or, a bet offer may be made that is never matched, but the judging of the bet contest that the offer is about may still be triggered.

The Core Modules we describe below are:

Module 1: Creating a Bet Contest (Product Contest and Bet Transaction Rules)

Module 2: Finding/Displaying a Bet at Any Stage in the Bet Process

Module 3: Risking Money on a Product—Making a Bet Choice, a Bet Offer

Module 4: Identifying Users and Displaying User Information

Module 5: Retracting Money Risked

Module 6: Matching Up Offers

Module 7: Paying the Costs of Judging

Module 8: Triggering the Judging

Module 9: Judging the Contest and Settling the Bet

Module 10: Dividing Money

Module 11: Charging Users

Module 1: Creating a Bet Contest (Product Contest and Bet Transaction Rules)

The invention provides a module that enables a user (an author) to create the rules of a bet contest which include:

(A) rules for a product contest and

(B) rules for the bet transaction (for risking money on the contest).

The product contest can be defined by any number of rules. At minimum, a user must name the competing products and specify how the contest is to be judged.

The bet transaction can be governed by a wide variety of rules specifying how bettors choose sides and risk money: how money is committed, when a commitment expires, when a commitment is sealed, how an offer may be retracted, how money is divided upon the settlement of the bet, and so forth. The bet transaction rules include payoff rules that define how much money a bettor will receive in exchange for the amount of money he has risked, if he chooses the winner of the product contest.

Further, the bet may include rules specifying how the judging is to be paid for.

Thus, this module enables a user to set up a competition, like a football game, and define rules about how people can bet on that game.

Accordingly, the medium will present forms for enabling a user to create and enter the data, terms and rules necessary to create a product contest and corresponding bet contract. Thus, the invention provides a method of (or medium for):

inputting a set of terms defining a product contest, said terms including:

a product name and at least one competing product,

a method of judging which is the better product,

rules defining how money is to be risked by bettors on the result of the contest.

For example, the medium might enable an author to input:

The names of the competing products: Bayer Aspirin and Costco Aspirin

The judging method: neutral expert decides which product is better

The payoff rules: even odds

The cost of judging: $1,000

In this module, the medium creates a bet record for the contest and for data that surround the contest, for example, who is betting on the contest, how much they are betting, and various other data described throughout this specification.

As noted, in practice, many if not all of the terms of the contest may be standard, and so, the selection of terms may be by default. An author will, at minimum, have to name the products that are competing.

At minimum, then, the invention provides for a method of (or medium for): inputting at least two product names that will compete into a pre-existing bet structure that defines a product contest along with bet transaction rules for risking money on that product contest.

Module 2: Finding/Displaying a Bet at Any Stage in the Bet Process

The purpose of product bets is to display them to people to communicate the relative value of products.

Therefore, the invention provides a module that enables a viewer to find and see the data defining and surrounding a bet, at any stage in the bet, from creation of a bet contest to the settlement of a bet contract.

This module can enable a viewer to see, for instance, the competing products, the bet rules, the amount of money risked on each product, who has risked money on a product, whether the bet is going to be judged, the result if any, and so forth.

Accordingly, the invention provides a method of (or medium for): enabling a user to find and view bet data by inputting a product name, also, by other types of keywords, such as a company name, author name and bettor name.

Module 3: Risking Money on a Product—Making a Bet Choice, a Bet Offer

This module enables a bettor to find a bet, choose a product in the bet, and then risk money that the product will win the bet contest.

(Note: A bettor may be an author of a bet, and may risk money while he is authoring the bet, but we will consider the authoring and risking of money as separate actions.)

Accordingly, the invention provides a method of (and medium for): enabling a bettor to find a bet and then pick a product in the product contest and commit to risking money on the outcome.

For example, a user might enter “Bayer Aspirin” into the medium and find the bet about Bayer vs. Costco. The user could then risk money that Bayer will win the bet contest.

The user's choice and amount of money at risk are displayed for viewers to see.

When a bettor makes a choice and risks money he is making a bet offer.

The medium can display all the bettors who have chosen each product and how much money each has risked, as well as the total amount of money risked on each product.

There does not need to be an opposing bettor. For example, all bettors may choose to risk money that Costco Aspirin will win.

An essential aspect of making a bet choice is the “price” at which money is risked. The kind of price will depend on the payoff rules in effect, which can vary widely. For example, in a variable odds bet, the price will be stated in odds, while in a security-type bet, the price will be stated in the price of a share of stock.

If the user can choose the price in a bet, then this module will enable him to specify (enter) the price he is willing to bet at.

The price may be standard, especially in the case of even-odds bets. If a bet is set up as even-odds only (or some other standard price) then a bettor can only choose one of the products to bet on and an amount of money to risk.

At minimum, then, a bet choice involves picking a product and specifying an amount of money to be risked on that product (for example, $1,000 on Costco Aspirin) at a specified odds or other price.

As noted, by making a product choice, by specifying an amount of money at risk, and by stating a price, a bettor has made a bet offer.

The method and medium provide for storing this offer, for enabling the bettor to display this offer and for other bettors and users to find this offer (see Module 2 above).

The method and medium can enable a bettor to add a variety of restrictions/conditions to a bet offer, as disclosed in U.S. Pat. Nos. 5,575,474 and 6,443,841. Below are just four:

A targeting restriction such that a bet offer is directed at a specific individual or entity (see Part 5 of this specification).

A lock-in condition that the bettor promises not to retract his bet offer for a specified period of time.

A condition that the bettor's offer will stand only if a specified amount of money has been contributed by other parties for paying for the judging.

A condition that the bettor's offer will only stand if enough of his stake has been covered by another bettor.

Module 4: Identifying Users and Displaying User Information

As is plain, in order to operate, the medium will include the ability to identify authors, bettors, judges and administrators. Viewers do not have to be identified.

The method and medium can also enable users to identify themselves and their expertise and credentials to the public. This capability is useful because who makes a bet offer can be important part to the communication value of the offer. Particularly important is a bettor's knowledge of the product being bet on or bet against. For instance, more information seems to be provided when the President of Costco Corporation is willing to back up his product with a bet offer rather than when an anonymous bettor makes an offer. Hence, a bettor may want to advertise himself when making a bet offer.

A bettor would normally decide how much information to provide about himself while making a bet choice, but he could add the information at a different time. This module, then, can enable a bettor to decide how much information to provide about himself for display as supplemental data to the bet choice being made.

Accordingly, the invention may provide a method of (or medium for) enabling a bettor to input and display:

his name

his company

his company's relationship to the product in the product contest-manufacturer, provider (in the case of a service), seller, or competitor

his title

any other relationship he might have to the product in a product contest, such as buyer or supplier or developer.

For convenience, the medium can enable a bettor to select from a menu or menus of options for describing one's position relative or to, or understanding of a product.

Also, for convenience, the medium could enable a user to store profile (biographical) data about himself and then select how much of that data is to be displayed along with a bet offer. Accordingly, the medium can include forms for enabling a bettor to enter profile data, or provide the bettor with the option of using data already stored in his user profile.

Accordingly, the invention may provide a method of (or medium for): storing and displaying profile data about bettors, in particular, data describing his company, his company's relationship to the product, he is risking money on, his title and data describing his relationship to the product he is risking money on.

A bettor will often be an entity, especially a company promoting its product or attacking a competitor's product.

Accordingly, the invention may provide a method of (or medium for): identifying a company representative authorized to make bet offers on behalf of a company, and identifying a bettor as a company and, further, storing and displaying a variety of data describing the company, to be viewed along with the company's bet offers.

The invention can also include processes for authenticating identity data provided by a user, whether that data is about an individual or an entity. Authentication of certain data, such as company affiliation, may be required, depending on the implementation.

Since authentication processes can cost money, the invention can also include processes for charging a user for authentication.

Further, the invention may provide a user with the option of being authenticated or not.

Further, the invention may provide means for displaying whether a user's purported identity other purported descriptive data have been authenticated or not.

Separately, the invention can include processes for enabling judges to enter profile data about themselves, and to display this profile data to bettors and viewers. This capability is useful because a judge's qualifications can be important for evaluating her opinion.

The invention can include means for keeping the identity of a judge secret from bettors until the judge has entered her decision, because making the judge public before a decision can increase the chance of cheating, i.e., that bettors will bribe the judge.

Module 5: Retracting Money Risked

This module enables a bettor to retract his bet choice. This module is useful but not strictly necessary. Whether and when a retraction is allowed will depend upon the implementation of the method.

A retraction becomes part of the bet record, stored by the medium, and can be displayed to viewers.

Accordingly, the invention provides a method of (or medium for): inputting a retraction of a bet choice and displaying that retraction.

If a retraction is allowed, the invention may include steps for assessing a retraction fee.

Module 6: Matching Up Offers

In this module, the medium matches up bet offers to arrive at bet contracts that define how money that is risked is to be divided upon the result of the product contest.

Many methods known in the art exist for matching up offers, and the inventive method and medium can include any of these methods.

Rules defining how offers are matched are part of the creation of a bet contest (and usually are standard).

Accordingly, the invention provides a method of (or medium for): matching up bet offers.

We note that the amount of money that is matched up may be critical in the decision as to whether to pay a judge to settle the bet (see Modules 7 and 8 below).

Module 7: Paying the Costs of Judging

This module enables users to pay for having the bet contest judged (features for paying for judging were disclosed in U.S. Pat. Nos. 5,575,474 and 6,443,841).

The costs of judging a product contest will vary according to the product contest rules provided in the creation of a bet.

More than one user may pay for the judging, and a user who is not a bettor—for instance, a company—may pay for the judging.

Accordingly, the invention provides a method of (or medium for): enabling users to commit to paying all or part of the judging costs.

The medium will enable users to see how much the judging costs and how much has been committed by other users. For example, a user who finds the Bayer Aspirin vs. Costco Aspirin bet may see that the cost of judging is $10,000. He may then see how much of this cost other users have committed to pay.

Accordingly, the invention provides a method of (or medium for): displaying who has contributed to paying for the judging and how much.

The method can also include rules for rebating money contributed for judging if the judging does not take place or costs less than projected.

The method can also include steps for enabling a user to commit to paying an amount for judging but only upon certain conditions being met. Examples of such conditions are how much money has been matched up against the user's bet offer, if any, and how much other people have committed to paying for the judging, and how much specified individuals have committed to paying.

Module 8: Triggering the Judging

In order for judging of the bet contest to take place, a number of conditions may have to be met. For instance, the judging must be paid for.

In this module, the medium checks whether the conditions for judging are met, and if so, informs a judge, thereby triggering the judging.

An administrator may also assist in the process. That is to say, an administrator may be informed by the medium that the conditions for judging are met, and then the administrator may locate a judge and instruct him to judge the contest. The administrator may also assist in transferring funds to the judge.

A bet contest might be judged even if opposing bettors do not exist. One or more users may want the products judged and pay for the judging, which can be enough to trigger the judging, after a specified period of time.

Accordingly, the invention provides a method of (or medium for): triggering the judging upon the satisfaction of trigger conditions set forth in the bet contest rules.

We note that the bet contest rules will specify at what point money can be risked on a product after the process for selecting the judge has been triggered. Accordingly, the inventive method can include steps for blocking bet offers from being made on a product after the process for selecting of a judge has been triggered. Likewise, the inventive medium will perform steps for blocking bet offers at the point specified by the bet rules.

Module 9: Judging the Contest and Settling the Bet

Judging may involve various tests on the products of the bet contest, but that is not the concern of this specification. The point is simply that a judging process will take place outside the medium and that the result of that judging will be entered into the medium by the judge or, by an administrator that the judge tells, or by an automated process.

Accordingly, the invention provides a method of (or medium for): storing the judge's decision and bet result and displaying it to users.

Module 10: Dividing Money

This module enables winning bettors to divide the money that has been risked, according to the payoff and division rules of a bet, assuming that the bet has been settled, and assuming that opposing bettors exist.

Most bets that people are familiar with are winner take all between two opposing parties, but many other possibilities exist—that is, many other division rules are possible.

Accordingly, the invention provides a method of (or medium for): dividing the money risked, as specified by the payoff and division rules, established in the creation of the bet.

Further, the method and medium provide for recording and displaying the division of money risked.

Module 11: Charging Users

This module enables the medium to charge users for their usage. The method and medium may include a variety of well-known processes for charging for information and for taking a commission on transactions.

### Part 2

Setting the Parameters (Terms and Rules) of a Product Bet Contest

In this Part 2 of the specification we describe how the inventive method enables a user to set up a bet contest for comparing products. We describe more inventive embodiments and features for this contest than were described in Part 1.

(In this Part 2 we do not describe embodiments or features for enabling users to risk money in a bet because, for clarity, we distinguish between creating a bet contest and risking money on the contest.)

A user sets up a product bet contest by entering into the inventive medium a set of parameters, also called terms and rules. The inventive medium will present the user with a form or the equivalent for setting these parameters. The contest parameters are stored and displayed so other users can react to them or simply view them.

We disclose these parameters below and disclose choices for each parameter.

In this Part 2 and the rest of this specification, we focus on two parameters in particular: the Comparison Set of Products and the Comparison Question. We focus on these two parameters because they, more than the others, distinguish the invention from other online betting methods and systems.

Other parameters, such as the selection of judges, are highly important but also apply more generically to other applications of bets as communication vehicles. We discuss the other parameters below because they are important parts of the invention, but we usually do not delve into features for these parameters. In most cases, where we have novel matter to disclose, we plan to disclose it in future patent applications.

The parameters we describe below are:

Parameter 1: Specifying the “Advertiser's” Product

Parameter 2: Specifying the Comparison Set of Products

Parameter 3: Specifying the Comparison Question

Parameter 4: Specifying Who Will Judge the Comparison Question

Parameter 5: Specifying the Cost of Judging the Comparison Question

Parameter 6: Specifying the Payoff Method (Rules)

Parameter 7: Specifying the Matching Rules

Parameter 8: Specifying the Retraction Rules

Parameter 9: Specifying the Trigger Conditions

Parameter 1: Specifying the “Advertiser's” Product

Usually, an author creating a bet contest is an advertiser who does so with the goal of demonstrating that a particular product is better than another product or products. For example, the marketing manager for Costco may want to demonstrate that Costco Aspirin is better than Bayer Aspirin.

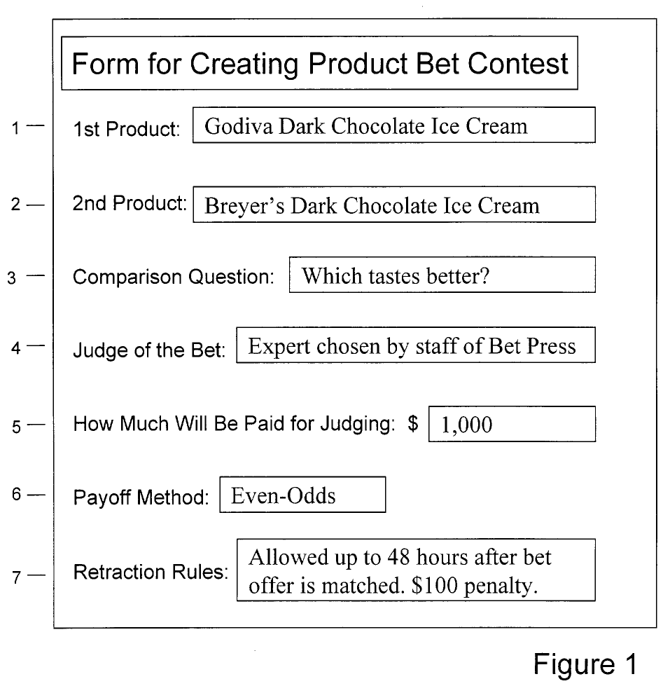

So, one parameter in a product contest specifies what we will call the “advertiser's product” (AP) that is to be pitted against another product or products that we will call the “comparison set” (described as Parameter 2 below). As shown in FIG. 1, we might also call the AP by the name first product (1).

However, an author may not be trying to showcase a particular product, but may simply be setting up an interesting contest, just as the promoter of a racetrack might set up a horse race, without having a preference as to which horse wins. In this case, the term “AP” is not really apt. Still, we will often use “AP” because it makes it easier to explain certain novel comparison sets below.

The invention enables a user to specify an AP by entering descriptors, including: product name, model number or other alphanumeric identifier, price or price range, size, quantity, location, warranty/guarantee, and time period (in the case of a service). Descriptors for products and services may differ. Often a service is identified by the name of the business that provides the service, as in, Mike's Pool Service. A service name will also often be a company name modified by the service offered, as in, John's Law Firm, Patent Litigation.

Accordingly, the invention provides a method of (or medium for):

inputting descriptors defining a first product, said descriptors including:

a company name,

a product or service name,

model number or other alphanumeric identifier,

price or price range,

size or quantity,

location,

warranty/guarantee,

time period (in the case of a service).

For example, the medium might enable an author to input:

Product name: Costco Aspirin, 200 mg.

Size: 500 count bottle

The list of descriptors above is not exhaustive, of course. Further, it should be noted that products can be described in many different ways using a variety of references. For example, a product could be described as “the top ranked mountain bike under $300 in Consumer Reports.” We explore some of these ways in Part 3.

Parameter 2: Specifying the Comparison Set of Products

As noted, a comparison set of products is the set of products that are to be compared to the AP and/or to each other. There may be only one product in the comparison set (2).

If the author enters the comparison set, he can enter descriptors, discussed above, to define each product that is competing. For example, Costco Aspirin, 200 mgs., 500 count and Bayer Aspirin, 200 mgs., 500 count. He may enter more than two products.

Accordingly, the invention provides a method of (or medium for):

inputting descriptors defining a product or products to be compared to a first product whose description has already been inputted.

As noted, an author of a contest may not care who wins the contest, but may want to create an interesting contest that will generate useful information and possibly attract bettors. In this case, it does not really make sense to refer to an AP being pitted against a comparison set, it makes more sense to say that the author enters a comparison set of products, or enables others to enter a comparison set.

Accordingly, the invention provides a method of (or medium for):

inputting descriptors defining a product or products to be compared to each other.

An alternative way of creating the comparison set is to define a product category and let other users supply the names of competitors. This method is similar to a horse race in which the entry requirements are specified and then any horse meeting those requirements can enter. In the case of a product contest, the author would define a product category using descriptors, and possibly the number of allowable competitors. Then other users could enter specific products that fit the category descriptors.

Accordingly, the invention provides a method of (or medium for):

inputting descriptors defining a product category, and

inputting products that fit that category.

In Part 3 we will describe a variety of useful comparison sets.

Parameter 3: Specifying the Comparison Question

Another essential parameter to specify is the comparison question that is to be decided/answered by a judge, supplying the outcome of the bet.

The comparison question (3) specifies what the product contest is about. To give a simplified example, a question might be, Which of these two products is better?

The judge's decision on the question is the outcome of the bet, and it is information that the bet provides to users. But, the judge's opinion is not the only information provided by a bet on the comparison question. The opinion of bettors who risk money, and even those that refuse to risk money, provide answers to the question. For example, if no manager at Bayer Aspirin is willing to bet that Bayer is a better aspirin than Costco aspirin, that unwillingness to bet provides an answer to the comparison question.

Accordingly, the invention provides a method of (or medium for):

inputting a comparison question that defines how the AP and comparison set product(s) are to be compared are compared.

To oversimplify, the purpose of the invention is to be a method or medium that provides answers to, and opinions on, the question: Which of these products is better (or best)?

The reason this question is an oversimplification is that it hides the actual complexity of the problem of comparing two (or more) products. There is no single, correct way to compare products and hence, no single, correct way to answer the simplistic question of which product is better than another.

Thus, we disclose several different comparison questions that lead to different, useful answers/opinions that fill specific information needs of advertisers and prospects.

A complete comparison question implies a judging procedure and a method for answering the question. For example, a more complete question than the one above might be: “Which of these two products is better according to a judge chosen by the following procedure . . . who is given the following amount of money and the following amount of time to evaluate the two products . . . ?”

The details of judging/answering the comparison question are important, practical aspects of the question, and we will discuss the selection of judges and the costs of judging as separate parameters (in sub-sections 4 and 5 just below).

In Part 4, we disclose useful comparison questions, the questions that advertisers want to be answered for prospects, the questions that prospects want answered about a product.

Parameter 4: Specifying Who Will Judge the Comparison Question

Once a comparison question is specified, a judge is required to decide the question.

Comparing two products is usually a subjective task, which means that human judging is usually required. In certain cases where “objective qualities”, such as price, are compared, a mechanical judge may be possible. Still, a human judge may be the ultimate recourse, because even qualities like price can have subjective or controversial aspects. So, the inventive method and medium will include steps and means (4) for specifying who will judge the bet contest—that is, who will decide the comparison question.

Accordingly, the invention provides a method of (or medium for):

enabling the author to specify who selects the judge of the bet and, possibly, how the judge is chosen.

Here are five different ways that a judge can be chosen:

The author chooses the judge.

The author can choose the qualifications of judge, but not e tactual judge, whose selection is decided by another party.

A designated neutral party can choose the judge. The qualifications of this neutral party can be set by default or the author can be given the choice of qualifications.

A set of customers can be chosen to judge the bet. How the customer judges are chosen can be highly variable.

The invention also provides a method of (or medium for):

displaying the qualifications of the judge or judges.

Parameter 5: Specifying the Cost of Judging the Comparison Question

The next parameter to specify is how much is to be paid for the judging, which can include a judge's fee, hourly rate, and expenses, if any. So, the inventive method and medium will include steps and means (5) for specifying how much will be paid for the judging of the bet contest.

Accordingly, the invention provides a method of (or medium for):

enabling the author to specify how much is to be paid for the judging.

A variety of choices exist:

The author may state the amount. The author may choose from a cost menu, such as $500, $1,000, $5,000, and so forth.

The author may state the amount of time the judge will spend. The author may choose from a cost menu, such as 1 hour, 5 hours, 10 hours, and so forth. The cost per hour may or may not be known.

The author may request a cost estimate from a designated third party. This cost estimate itself may cost something to produce. The cost estimate can be for the total job of judging or an hourly rate.

Or, the author may request an estimate by specified third party says and create contest based on this cost estimate. The author will specify how much is to be paid for this estimate (because the estimate will cost money to produce).

Parameter 6: Specifying the Payoff Method (Rules)

Payoff rules govern the proportion of money that opponents in a bet have to risk and how the money risked is divided upon the outcome of the contest. The inventive method and medium will include steps and means (6) for specifying the payoff rules.

Accordingly, the invention provides a method of (or medium for):

enabling the author to specify the payoff rules.

A wide range of rules is possible.

A person who risks money in a bet will make an offer using the payoff rules for the bet.

As noted, the payoff rules define how a bet offer is “priced.”

The best-known payoff rule, perhaps, is even-odds in which a bettor offers to risk $1 for each $1 an opponent risks. The person who picks the correct outcome out of two outcomes then wins the pot.

In a variable odds bet the proportions of money risked will be set by the odds that are offered, usually in X-Y form.

The payoff rules can allow for a bettor to create a “security,” like a pseudo-stock, whose ultimate value is determined upon the outcome of the contest. This security can be sold before the outcome is known.

(As an aside, if more than two products are compared, and if variable odds are used, as in horse race betting, users can take the current odds offered for each product as a measure of the relative value of those products.)

In addition to odds-based payoff rules, other kinds of rules can be created. For example, a judge may score competing products on a scale, say 1-100, and the difference between the products can be the basis for how much money a bettor wins from other bettors. That is, the bettor who has the best estimate of how the products will score, can win an amount of money that is based on how much closer he is to the score than opposing bettors.

(As an aside, if more than two products are compared, and if the payoff rules are based on a scale, then users can take the current bets offered for each product as a measure of the relative value of those products.

Parameter 7: Specifying the Matching Rules

As noted, many well-known methods exist for matching up bet offers.

We do not delve into the mechanics of how bettors on the same “side” of a bet can combine their stakes, and how the money can be apportioned to the winners.

Rules defining how offers are matched are part of the creation of a bet contest (and usually are standard).

Accordingly, we note that the invention provides a method of (or medium for):

enabling an author to create rules for matching up bet offers.

It may be useful to direct—to restrict—a bet offer to a particular individual, or set of individuals, or to a company. Accordingly, the invention can also provide a method of (or medium for):

enabling an author to direct/restrict a bet offer to a particular individual or individuals, or to a particular company.

Parameter 8: Specifying the Retraction Rules

Rules for retracting money in a bet contest also may need to be specified. So, the inventive method and medium will include steps and means (7) for specifying the retraction rules.

Accordingly, we note that the invention can provide a method of (or medium for):

enabling an author to create rules for retracting money pledged in a bet.

Note: Money risked as a stake in a bet can be treated differently from money that is committed for paying for the judging of the bet.

Parameter 9: Specifying the Trigger Conditions

Rules for triggering the judging of the bet, and the commitment of all the monies needed for executing the bet, may also need to be specified. Normally, these rules will be standard.

A variety of different rules are possible and we do not delve into these possibilities, but may do so in a separate patent application.

Accordingly, we note that the invention can provide a method of (or medium for):

enabling an author to create rules for triggering the judging of the product contest.

I claim:

1. A method of displaying and transacting bets that compare two or more products, the method comprising:
enabling a user to create a product bet contest by entering data into an online computer database,
said data defining: at least two products being compared, the rules for judging which product is better and determining the outcome of the product contest, said data also defining bet transaction rules, said rules including payoff and offer-matching rules for how money is to be risked by bettors on products in said contest;
enabling users to search and view product bet contests that have been created by other users;
enabling users to choose any product in a bet contest and make a bet offer by risking money on that product according to said payoff rules;
enabling users to search and view bet offers that have been made by other users; matching up bet offers in said database according to said bet transaction rules, thereby creating bet agreements;
enabling users to search and view bet agreements;
enabling users to pay for the costs of judging said contest;
triggering the judging of said contest, or not, according to said bet transaction rules;
if judging has been triggered, enabling a judge to enter the outcome of said contest;
if a judge has entered the outcome of said contest, dividing the money risked on a product or products in said contest according to said outcome and said bet transaction rules.
if judging has been triggered, enabling a judge to enter the outcome of said contest;
if a judge has entered the outcome of said contest, dividing the money risked on a product or products in said contest according to said outcome and said bet transaction rules.
